(19) United States
(12) Patent Application Publication
(10) Pub. No.: US 2008/0282920 A1
(43) Pub. Date: Nov. 20, 2008

(54) Device for Feeding Printing Plates to a Plate Cylinder and Printing Unit Having the Device

(75) Inventors: Martin Greive, Schriesheim (DE); Alexander Knabe, Heidelberg (DE)

Correspondence Address: LERNER GREENBERG STEMER LLP, P O BOX 2480, HOLLYWOOD, FL, 33022-2480, US

(73) Assignee: HEIDELBERGER DRUCKMASCHINEN AG, Heidelberg (DE)

(21) Appl. No.: 12/120,631

(22) Filed: May 14, 2008

(30) Foreign Application Priority Data
May 14, 2007 (DE) 10 2007 022 554.9

(51) Int. Cl. B41F 27/06

(52) U.S. Cl. 101/477

(57) ABSTRACT

A device for feeding printing plates to a plate cylinder includes a pressure roller for pressing the printing plate against the circumferential surface of the plate cylinder when the printing plate is being mounted. In order to compensate for uneven pressing forces resulting from a bending of the pressure roller, cylindrical segments are provided that have different widths and/or different diameters and/or different distances between the segments. A printing unit of a rotary printing press having the device, is also provided.

### CROSS-REFERENCE TO RELATED APPLICATION

This application claims the priority, under 35 U.S.C. §119, of German Patent Application DE 10 2007 022 554.9, filed May 14, 2007; the prior application is herewith incorporated by reference in its entirety.

### BACKGROUND OF THE INVENTION

### Field of the Invention

The invention relates to a device having a pressure roller for feeding printing plates to a plate cylinder and for pressing a printing plate against a surface of the plate cylinder in order to ensure that the printing plate is mounted correctly. The invention also relates to a printing unit having the device.

Such a device is known from German Published, Non-Prosecuted Patent Application DE 100 01 328 A1. In order to compensate for a bending of a pressure roller and thus to achieve a better pressure distribution of the pressing force, the pressure roller therein is cambered or disposed at an angle with respect to the plate cylinder axis.

A further pressure roller is disclosed in European Patent Application EP 0 679 513 A2, corresponding to U.S. Pat. No. 5,738,015. In that device, the pressure roller is formed by a number of segment disks disposed at equal distances from each other.

### BRIEF SUMMARY OF THE INVENTION

It is accordingly an object of the invention to provide a device for feeding printing plates to a plate cylinder and a printing unit having the device, which overcome the hereinafore-mentioned disadvantages of the heretofore-known devices of this general type and which provide an alternative pressure roller that allows compensation for uneven pressing forces caused by a bending of the pressure roller.

With the foregoing and other objects in view there is provided, in accordance with the invention, a device for feeding printing plates to a plate cylinder. The device comprises a pressure roller disposed axially parallel to the plate cylinder for applying pressure to the printing plate. The pressure roller includes cylindrical segments having different axial widths.

A particular advantage of the invention is that the pressing forces that the pressure roller applies to the printing plate to be mounted are constant across the width of the printing plate. As a result, correct positioning of the printing plate on the plate cylinder is ensured.

In accordance with another feature of the invention, the pressure roller is formed by segments that have different widths and are spaced apart from each other and the widths thereof become smaller from the center towards the ends of the roller.

With the objects of the invention in view, there is also provided a device for feeding printing plates to a plate cylinder. The device comprises a pressure roller disposed axially parallel to the plate cylinder for applying pressure to the printing plate. The pressure roller includes cylindrical segments having different diameters.

In accordance with a further feature of the invention, the segments have different diameters and the spaced-apart segments disposed at the center having a larger diameter than in the end regions.

With the objects of the invention in view, there is furthermore provided a device for feeding printing plates to a plate cylinder. The device comprises a pressure roller disposed axially parallel to the plate cylinder for applying pressure to the printing plate. The pressure roller includes cylindrical segments disposed at different distances between the segments.

In accordance with an added feature of the invention, the cylinder-shaped segments have the same width, but the distances between the segments advantageously vary, that is the distances at the center of the pressure roller are smaller than in the end regions.

In accordance with an additional feature of the invention, metal sleeves may be provided between the segments to make the shaft more rigid. As a result, bending of the pressure roller is minimized.

With the objects of the invention in view, there is concomitantly provided a printing unit of a rotary printing press. The printing unit comprises a device according to the invention.

Other features which are considered as characteristic for the invention are set forth in the appended claims.

Although the invention is illustrated and described herein as embodied in a device for feeding printing plates to a plate cylinder and a printing unit having the device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, longitudinal-sectional view of a sheet-fed printing press;

FIG. 2 is an enlarged, sectional view of a printing unit;

FIG. 3 is a fragmentary, partly-sectional, front-elevational view of a plate cylinder including a pressure roller for a printing plate;

FIG. 4 is a view similar to FIG. 3 of a plate cylinder including an alternative pressure roller for a printing plate; and

FIG. 5 is a view similar to FIGS. 3 and 4 of a plate cylinder including a third embodiment of the pressure roller for a printing plate.

### DETAILED DESCRIPTION OF THE INVENTION

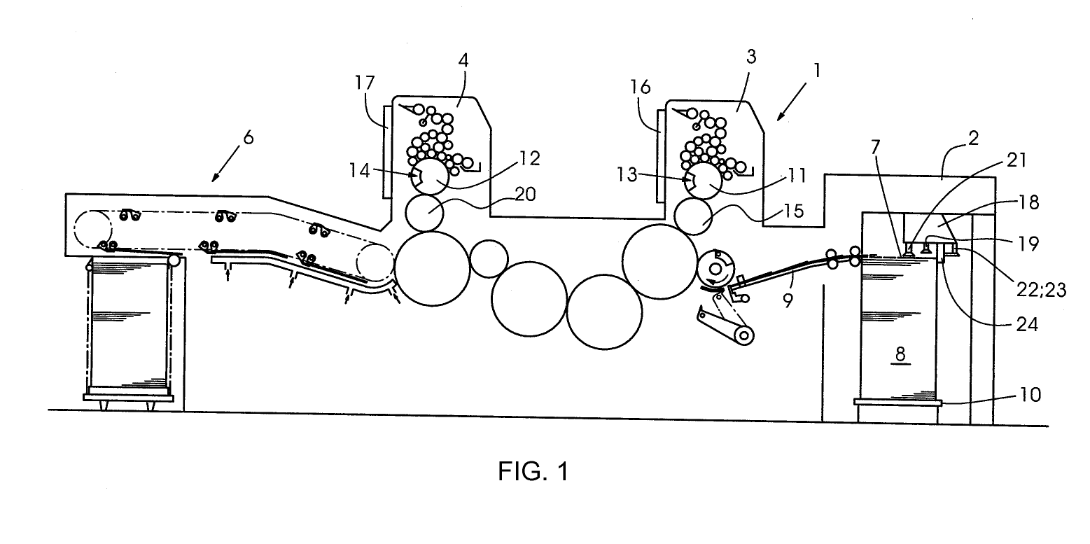

Referring now to the figures of the drawings in detail and first, particularly, to FIG. 1 thereof, there is seen a machine, for example a printing press 1, for processing sheets 7. The printing press 1 includes a feeder 2, at least one printing unit 3, 4, and a delivery 6. The sheets 7 are taken from a sheet stack 8 and are fed across a feed table 9 to the printing units 3 and 4 individually or in shingled formation. Each printing unit includes a plate cylinder 11, 12 and a blanket cylinder 15, 20 cooperating with the respective plate cylinder 11, 12 as is known in the art. Each of the plate cylinders 11, 12 includes a device 13, 14 for mounting flexible printing plates. In addition, a device 16, 17 for semiautomatic or fully automatic plate changing is associated with each of the plate cylinders 11, 12.

The sheet stack 8 rests on a stack plate 10 that can be lifted in a controlled manner. Sheets 7 are removed from the upper side of the sheet stack 8 through the use of what is known as a suction head 18, which includes, among other elements, a number of lifting and dragging suckers 19, 21 for separating the sheets 7. In addition, blowers 22 for loosening the upper sheet layers and sensing elements 23 for initiating a lifting of the stack are provided. A number of lateral and rear stops 24 are provided for aligning the sheet stack 8, in particular the upper sheets 7 in the stack 8.

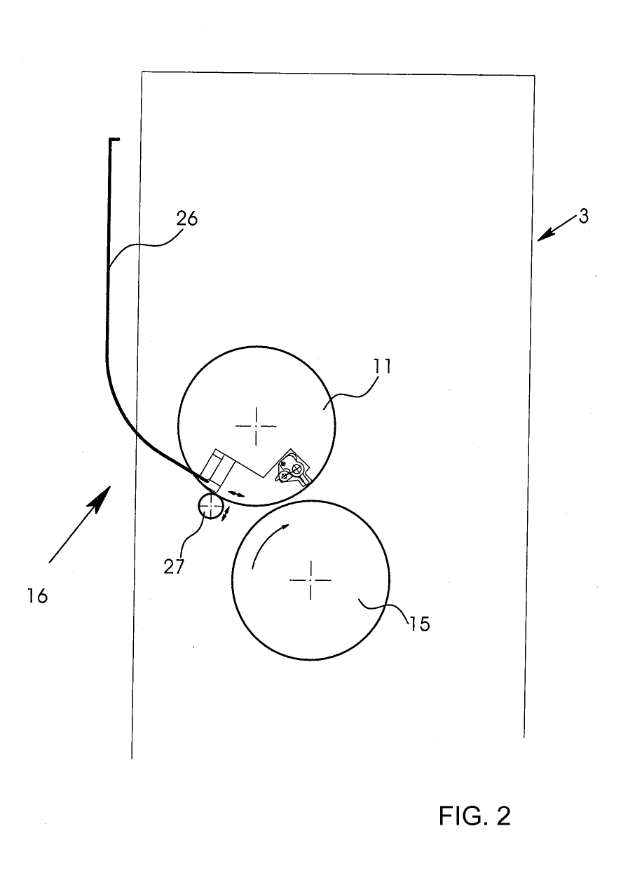

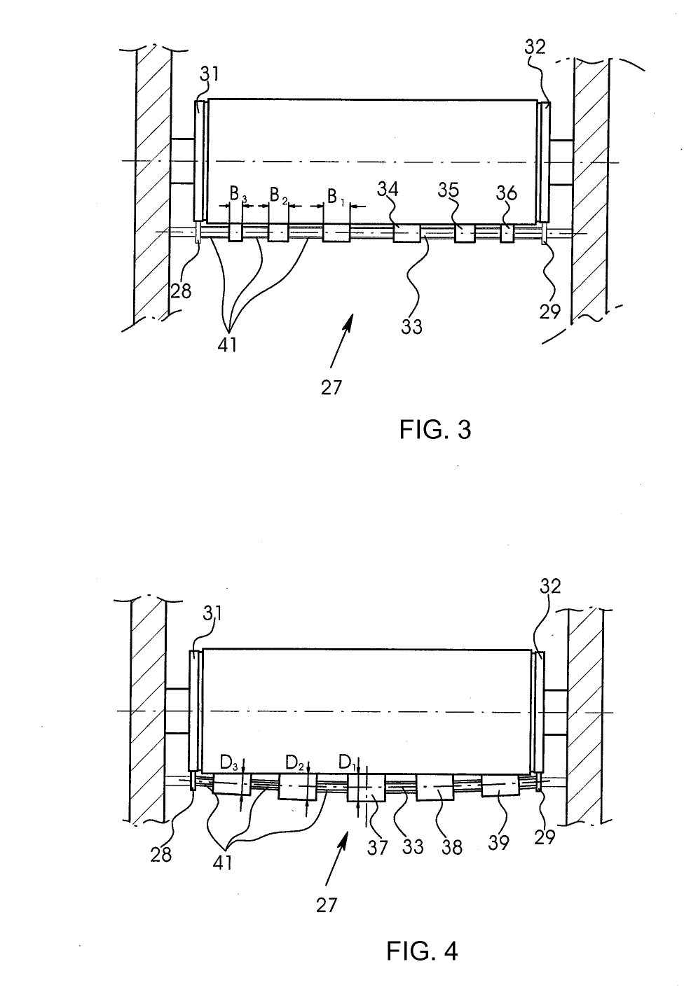

FIG. 2 represents a printing unit 3 including a device 16. The device 16 basically includes a pressure roller 27, which is disposed at a short distance from the circumferential surface of the plate cylinder 11 and is parallel to the plate cylinder 11. As is seen in FIGS. 3, 4 and 5, the pressure roller 27 can be engaged with the circumferential surface of the plate cylinder 11 in order to feed a new printing plate 26. The pressure roller 27 is preferably driven by friction rollers 28, 29 that are brought into contact with what are known as bearer rings 31, 32 of the plate cylinder 11 when the pressure roller 27 is engaged with the plate cylinder 11 and are driven by friction.

Alternatively, the pressure roller 27 may be driven by an electric motor or by a gearing mechanism or by the printing plate itself.

In a first embodiment, which is shown in FIG. 3, the pressure roller 27 is formed of a shaft 33 that is supported for rotation and carries a number of cylindrical segments 34, 35, 36 that are spaced apart from each other and fixed to rotate with the shaft 33. The segments 34 that are located at a central region of the shaft 33 have a greater axial width B₁ than the segments 35, and the latter have a greater width B₂ than the segments 36, which are located at end regions. Thus, in theory, when the pressure roller 27 is engaged with the printing plate 26 disposed on the plate cylinder 11, different pressing forces occur as a function of the widths B₁, B₂, B₃ of the segments 34, 35, 36. At the same deformation, the wider segments 34 generate a stronger force. As the pressure roller 27 is bent by the pressure forces, the deformation and consequently the pressing force is smaller at the center of the plate. The wider segments 34 at the center of the pressure roller 27 compensate for these smaller forces to ensure a uniform pressing force of the different-width segments 34 to 36 against the printing plate 26.

In a second embodiment, which is shown in FIG. 4, cylindrical segments 37, 38, 39 are provided that have the same axial width, but different diameters D₁, D₂, D₃. The diameters D₁ of the segments 37 at the center are larger than that of the segments 39 disposed in the end regions. It may also be seen that some of the segments 38, 39 are optionally tapered toward a respective end of the pressure roller 27.

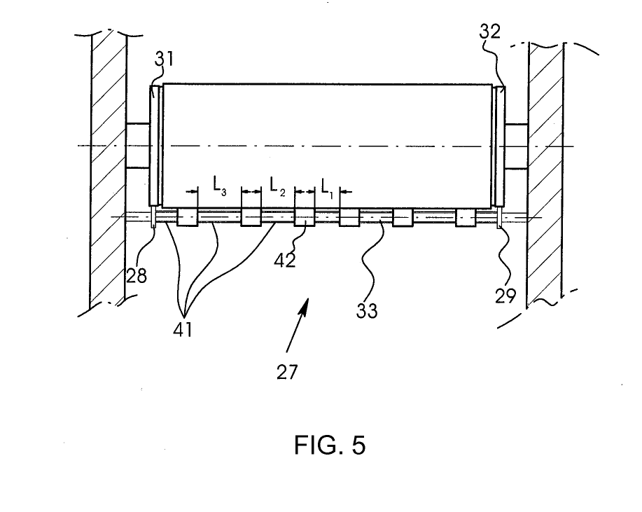

In a third embodiment, which is shown in FIG. 5, cylindrical segments 42 that have the same width and the same diameter are disposed at different distances L₁, L₂, L₃ from each other. The distances L₁ between the segments 42 disposed at the center are smaller than the distances between the segments 42 disposed in the end regions.

In order to minimize bending of the pressure roller 27, it is proposed to reinforce the roller 27 by providing respective reinforcement sleeves or bushings 41 between the individual segments.

Furthermore, the pressing force upon bending can also be controlled through the hardness of the segment material. In this context, foamed material with different pore sizes can be used.

An alternative construction is to introduce axially parallel bores to make room for the segment material to escape into.

An optimized embodiment includes a combination of segments 34, 35, 36 with different widths B₁, B₂, B₃, segments 37, 38, 39 with different diameters D₁, D₂, D₃, or segments 42 with different distances L₁, L₂, L₃ therebetween.

1. A device for feeding printing plates to a plate cylinder, the device comprising:
a pressure roller disposed axially parallel to the plate cylinder for applying pressure to the printing plate, said pressure roller including cylindrical segments having different axial widths.

2. The device according to claim 1, wherein said widths of said cylindrical segments are decreased from a center towards end regions of said pressure roller.

3. A device for feeding printing plates to a plate cylinder, the device comprising:
a pressure roller disposed axially parallel to the plate cylinder for applying pressure to the printing plate, said pressure roller including cylindrical segments having different diameters.

4. The device according to claim 3, wherein said diameters of said cylindrical segments are decreased from a center towards end regions of said pressure roller.

5. A device for feeding printing plates to a plate cylinder, the device comprising:
a pressure roller disposed axially parallel to the plate cylinder for applying pressure to the printing plate, said pressure roller including a combination of cylindrical segments having different widths and cylindrical segments having different diameters.

6. A device for feeding printing plates to a plate cylinder, the device comprising:
a pressure roller disposed axially parallel to the plate cylinder for applying pressure to the printing plate, said pressure roller including cylindrical segments disposed at different distances between said segments.

7. The device according to claim 1, which further comprises reinforcement sleeves or bushings each disposed between a respective two of said cylindrical segments or at an end of said pressure roller.

8. The device according to claim 3, which further comprises reinforcement sleeves or bushings each disposed between a respective two of said cylindrical segments or at an end of said pressure roller.

9. The device according to claim 6, which further comprises reinforcement sleeves or bushings each disposed between a respective two of said cylindrical segments or at an end of said pressure roller.

10. The device according to claim 6, wherein some of said segments are tapered toward a respective end of said pressure roller.

11. A printing unit of a rotary printing press, the printing unit comprising a device according to claim 1.

12. A printing unit of a rotary printing press, the printing unit comprising a device according to claim 3.

13. A printing unit of a rotary printing press, the printing unit comprising a device according to claim 5.

14. A printing unit of a rotary printing press, the printing unit comprising a device according to claim 6.
